(19) United States
(12) Patent Application Publication
(10) Pub. No.: US 2019/0245213 A1
(43) Pub. Date: Aug. 8, 2019

(54) REDOX REACTION ELECTRODE AND FUEL BATTERY

(71) Applicant: DENSO CORPORATION, Kariya-city (JP)

(72) Inventors: Keisuke FUGANE, Kariya-city (JP); Tomoya ITAKURA, Kariya-city (JP); Takashi SATO, Kariya-city (JP)

(21) Appl. No.: 16/256,000

(22) Filed: Jan. 24, 2019

(30) Foreign Application Priority Data
Feb. 5, 2018 (JP) 2018-18286
May 15, 2018 (JP) 2018-93920

(51) Int. Cl. H01M 4/86; H01M 4/92

(52) U.S. Cl. CPC H01M 4/8668; H01M 4/926

(57) ABSTRACT

A redox reaction electrode includes a catalyst carrier, a Pt catalyst supported on the catalyst carrier, and an ionomer having proton conductivity. The ionomer contains H₄PO₄⁺. As a result, the redox reaction electrode has improved redox performance. A fuel battery includes the redox reaction electrode and an electrolyte disposed to be in contact with the redox reaction electrode.

### CROSS REFERENCE TO RELATED APPLICATION

The present application claims the benefit of priority from Japanese Patent Application No. 2018-18286 filed on Feb. 5, 2018 and Japanese Patent Application No. 2018-93920 filed on May 15, 2018. The entire disclosures of the above applications are incorporated herein by reference.

### TECHNICAL FIELD

The present disclosure relates to a redox reaction electrode and a fuel battery using the redox reaction electrode.

### BACKGROUND

In a fuel battery, protons (H⁺) and oxygen (O₂) react with each other at cathode to generate water (H₂O). An electrolyte used in the fuel battery contains a carrier that transfers protons (H⁺) from anode to cathode.

### SUMMARY

The present disclosure provides an electrode including a catalyst carrier, a Pt catalyst, and an ionomer that contains H₄PO₄⁺.

### BRIEF DESCRIPTION OF THE DRAWINGS

The above and other objects, features and advantages of the present disclosure will become more apparent from the following detailed description made with reference to the accompanying drawings in which:

FIG. 1 is a conceptional diagram showing a fuel battery cell according to an embodiment of the present disclosure;

FIG. 2 is an enlarged view of a part of a catalyst layer;

FIG. 3 is a diagram showing proton carriers of Examples 1, 2 and Comparative Examples 1 to 3;

FIG. 4 is a diagram showing NMR spectra of electrolytic solutions of Example 1 and Comparative Example 1;

FIG. 5 is a diagram showing cyclic voltammograms of Example 1 and Comparative Example 1;

FIG. 6 is a diagram showing cyclic voltammograms of Example 2 and Comparative Example 2;

FIG. 7 is a diagram showing cyclic voltammograms of Example 1 and Comparative Example 3;

FIG. 8 is a diagram showing redox performances of Examples 1, 2 and Comparative Examples 1 to 3;

FIG. 9 is a diagram showing a relationship between molar ratios of H₃PO₄ to strong acid and chemical shifts measured by NMR in Examples 3 to 6 and Comparative Example 4; and

FIG. 10 is a diagram showing redox performances of Examples 3 to 6 and Comparative Examples 4.

### DETAILED DESCRIPTION

Hereinafter, embodiments of the present disclosure will be described with reference to the drawings. In the present embodiment, the redox reaction electrode of the present disclosure is applied to an electrode for a fuel battery.

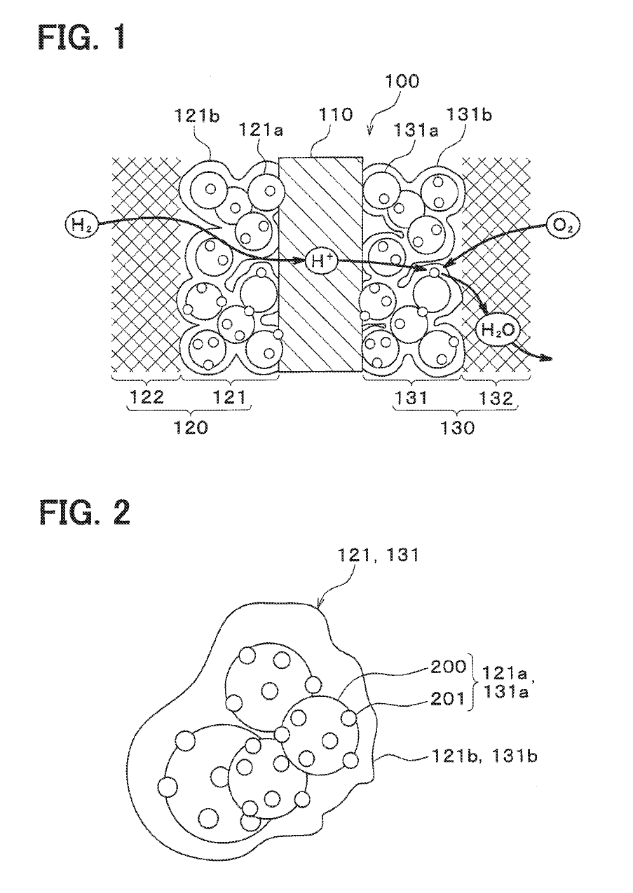

As shown in FIG. 1, a fuel battery cell 100 includes a pair of electrodes 120 and 130, and an electrolyte membrane 110 interposed between the pair of electrodes. The pair of electrodes 120 and 130 includes an anode electrode 120 and a cathode electrode 130. The anode electrode 120 is also referred to as a hydrogen electrode and the cathode electrode 130 is also referred to as an air electrode. The cathode electrode 130 corresponds to a redox reaction electrode, and the fuel battery cell 100 corresponds to a fuel battery.

The fuel battery cell 100 outputs electric energy using an electrochemical reaction between hydrogen and oxygen in air. The fuel battery cell 100 is provided as a basic unit, and a plurality of the fuel battery cells 100 are stacked as a stack structure to be used. Hydrogen may be referred to as fuel gas and oxygen in the air may be referred to as oxidant gas.

When the anode electrode 120 is supplied with hydrogen and the cathode electrode 130 is supplied with air, hydrogen and oxygen electrochemically react with each other to output electric energy as described below.

(Anode Side) H₂→2H⁺+2e⁻

(Cathode Side) 2H³⁰+½O₂+2e⁻→H₂O

In this case, in the anode electrode 120, hydrogen is ionized into electron (e⁻) and proton (H⁺) by the catalytic reaction, and the proton moves through the electrolyte membrane 110. On the other hand, in the cathode electrode 130, the protons migrating from the anode electrode 120 by the catalytic reaction, electrons flowing from the outside, and oxygen (O₂) in the air react to generate water (H₂O).

In the fuel battery cell 100 of the present embodiment, power generation is performed without humidifying the electrolyte membrane 110. That is, during operation of the fuel battery cell 100, dry air is supplied to the cathode electrode 130. Therefore, the fuel battery cell 100 can generate power at a temperature equal to or higher than 100 degrees Celsius (° C.).

The electrolyte membrane 110 is made of a proton conductor containing a metal ion, an oxo anion and a proton coordinating molecule. In the proton conductor, at least one of the oxo anion and the proton coordinating molecule is coordinated to the metal ion to form a coordination polymer.

The metal ion contained in the proton conductor is not particularly limited. However, from the viewpoint of ease of forming a coordination bond with the oxo anion and/or the proton coordinating molecule, a transition metal ion with higher periodic number and a typical metal ion are preferable. Among the above metal ions, cobalt ions, copper ions, zinc ions, and gallium ions are preferable. In the electrolyte membrane 110 of the present embodiment, the zinc ion is used as the metal ion.

As the oxo anion contained in the proton conductor, for example, phosphate ion, sulfate ion and the like may be used. From the viewpoint of chemical stability against hydrogen, the phosphate ion is preferable. In the electrolyte membrane 110 of the present embodiment, the phosphate ion is used as the oxo anion.

The proton coordinating molecule contained in the proton conductor is a molecule having preferably two or more coordination sites for coordinating protons in the molecule. From the viewpoint of ionic conductivity, imidazole, triazole, benzimidazole, benzotriazole, and derivatives thereof having a coordination site excellent in the balance between proton coordination and emission are preferable. In the electrolyte membrane 110 of the present embodiment, triazole is used as the proton coordinating molecule.

The anode electrode 120 includes an anode catalyst layer 121 and an anode diffusion layer 122. The anode catalyst layer 121 is disposed in close contact with a surface of the electrolyte membrane 110 adjacent to the anode electrode. The anode diffusion layer 122 is disposed on an outer side of the anode catalyst layer 121. The cathode electrode 130 includes a cathode catalyst layer 131 and a cathode diffusion layer 132. The cathode catalyst layer 131 is disposed in close contact with a surface of the electrolyte membrane 110 adjacent to the cathode electrode. The cathode diffusion layer 132 is disposed on an outer side of the cathode catalyst layer 131.

As shown in FIG. 2, the catalyst layers 121, 131 include catalyst carrying carbons 121a, 131a and ionomers 121b, 131b covering the catalyst carrying carbons 121a, 131a. In the example of FIG. 2, the ionomers 121b and 131b encompasses the catalyst carrying carbons 121a and 131a. Each of the catalyst carrying carbons 121a and 131a includes a carbon carrier 200 and Pt particles 201 supported on the carbon carrier 200. The carbon carrier 200 corresponds to a catalyst carrier. Carbon fine powder called as carbon black is used as the carbon carrier 200. The Pt particles 201 are catalysts that promote electrochemical reaction. The Pt particles 201 are supported on the surface of the carbon carrier 200. The ionomers 121b and 131b correspond to proton conductors. The ionomers 121b and 131b contain a polymer as a binder and a proton carrier that is a proton conductive material. Each of the diffusion layers 122, 132 is made of carbon cloth or the like.

Hereinafter, a method for manufacturing the electrodes 120 and 130 will be described. First, particulate catalyst carrying carbons 121a, 131a and ionomers 121b, 131b, which include the polymer and the proton carrier, are mixed in a solvent such as ethanol to form ink. The ink is coated on the carbon cloth constituting the diffusion layers 122, 132 and dried. In this way, the catalyst layers 121, 131 and the diffusion layers 122, 132 constituting the electrodes 120, 130 are obtained.

As the proton carrier contained in the anode ionomer 121b, H₃PO₄ may be used. Further, as the polymer contained in the anode ionomer 121b, polyvinylidene fluoride (PVDF), polytetrafluoroethylene (PTFE), polybenzimidazole, polyetherketone, polyetherimide, polysulfone, perfluorosulfonic acid or the like may be used.

In the present embodiment, H₄PO₄⁺ is used as the proton carrier contained in the cathode ionomer 131b. In the step of forming the cathode catalyst layer 131, H₃PO₄ and a strong acid having higher acidity than H₃PO₄ coexist in the solvent, whereby H₃PO₄ receives H⁺ from the strong acid to generate H₄PO₄⁺. In order to increase the generation rate of H₄PO₄⁺ as much as possible, molar ratio of phosphoric acid to the strong add is preferably 1 or less.

The “phosphoric acid” In this specification mainly includes H₃PO₄ and H₄PO₄⁺ in which H⁺ is bonded to H₃PO₄. That is, in the step of forming the cathode catalyst layer 131, the molar ratio of H₃PO₄ to the strong acid is 1 or less. After the cathode catalyst layer 131 is formed (that is, after H₄PO₄⁺ is generated), molar ratio of the sum of H₄PO₄⁺ and H₃PO₄ to the strong add is 1 or less. In addition, molar number of the strong add contains ions of the strong add that released H⁺.

As the polymer contained in the cathode ionomer 131b, a strong acid polymer may be used. The strong add polymer is a polymer as a binder and is a strong acid for generating H₄PO₄⁺. As the strong add polymer, a polymer having a sulfone group may be used. As the polymer having a sulfone group, for example, perfluorosulfonic acid polymer, sulfonated polyetheretherketone, or a polymer having a sulfonated acetylene skeleton may be used.

Instead of the strong add polymer, a polymer may be used in combination with a strong acid. For example, the strong acid Includes at least one add selected from sulfuric acid, hydrochloric add, nitric acid, perchloric acid, trifluoromethanesulfonic acid or 1,1,1-trifluoro-N-[(trifluoromethyl)sulfonyl]methanesulfonamide. In this case, one kind of strong acid may be used alone, or plural kinds of strong acids may be used in combination. Also, the polymer used in combination with the strong acid may not be a strong acid polymer.

H₄PO₄⁺ contained in the cathode ionomer 131b has high proton supply property to the Pt catalyst. In addition, H₄PO₄⁺ is hardly adsorbed on Pt at the cathode potential in the operating range of the fuel battery cell 100. Therefore, decrease of active sites of the Pt catalyst is suppressed.

When the strong acid polymer having the sulfone group is used, the sulfone group of the strong add polymer and H₄PO₄⁺ strongly bind by ionic bond. Therefore, H₄PO₄⁺ is not easily eluted from the cathode electrode 130 even when the fuel battery cell 100 is used for a long time.

Next, redox efficiency of the cathode electrode 130 of the present embodiment will be described using Examples 1, 2 and Comparative Examples 1 to 3. The oxygen reduction activity was evaluated using a rotating disk electrode. For the rotating disk electrode, a Pt plate (electrode area: 0.196 cm²) was used as a working electrode, a Pt wire was used as a counter electrode, and a standard hydrogen electrode (SHE) was used as a reference electrode. As the electrolytic solution, 1-Butyl-1-methylpyrrolidiniumBis(trifluoromethanesulfonyl)imide was used. The electrode rotation speed was 400 rpm, and the cell temperature was 100° C.

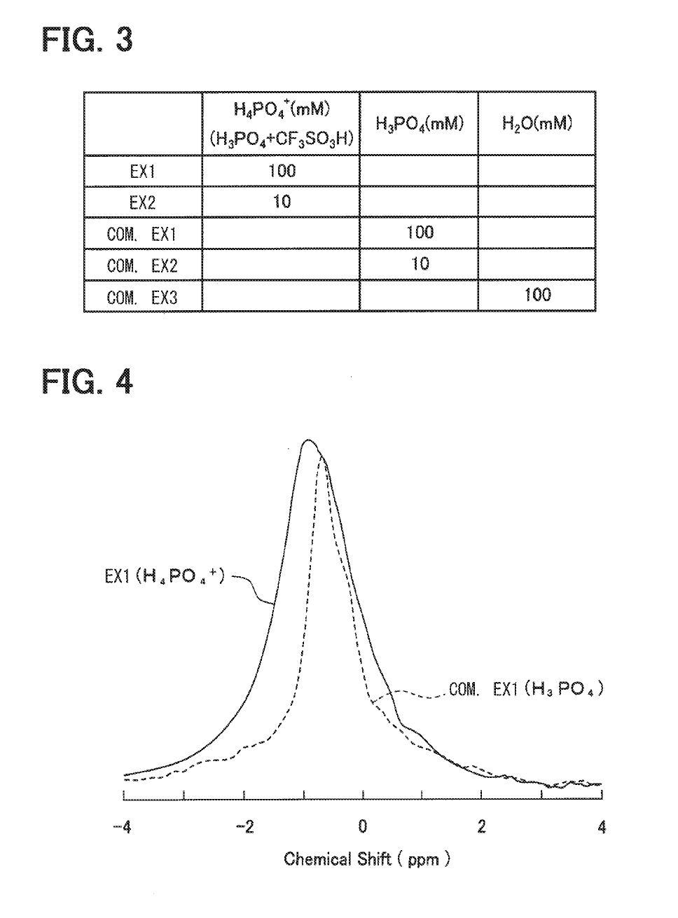

As shown in FIG. 3, in Examples 1, 2 (EX 1, 2) and Comparative Examples 1 to 3 (COM. EX 1 to 3), types and amounts of proton carriers added to the electrolytic solution were varied. In Examples 1 and 2, H₄PO₄⁺ was used as a proton carrier. In Comparative Examples 1 and 2, H₃PO₄ was used as a proton carrier. In Comparative Example 3, H₂O was used as a proton carrier. In Examples 1 and 2, H₃PO₄ and a strong acid coexist in the electrolytic solution to generate H₄PO₄⁺. Trifluoromethanesulfonic acid (CF₃SO₃H) was used as a strong acid.

In Example 1, 100 mM of H₃PO₄ and 100 mM of strong acid were added to the electrolytic solution to generate H₄PO₄⁺. In Example 2, 10 mM of H₃PO₄ and 10 mM of strong acid were added to the electrolytic solution to generate H₄PO₄⁺. In Comparative Example 1, 100 mM of H₃PO₄ was added to the electrolytic solution. In Comparative Example 2, 10 mM of H₃PO₄ was added to the electrolytic solution. In Comparative Example 3, 100 mM of H₂O was added to the electrolytic solution.

The generation rate of H₄PO₄⁺ in Example 1 will be described with reference to FIG. 4. In Example 1, H₄PO₄⁺ and H₃PO₄ exist in the electrolytic solution, and in Comparative Example 1, only H₃PO₄ exists in the electrolytic solution. As shown in FIG. 4, compared to NMR spectrum of Comparative Example 1 corresponding to H₃PO₄, peak of chemical shift is shifted to lower magnetic field, which is a left side in the NMR spectrum of Example 1. This result indicates that H₄PO₄⁺ is generated in Example 1 in which H₃PO₄ and the strong acid are mixed.

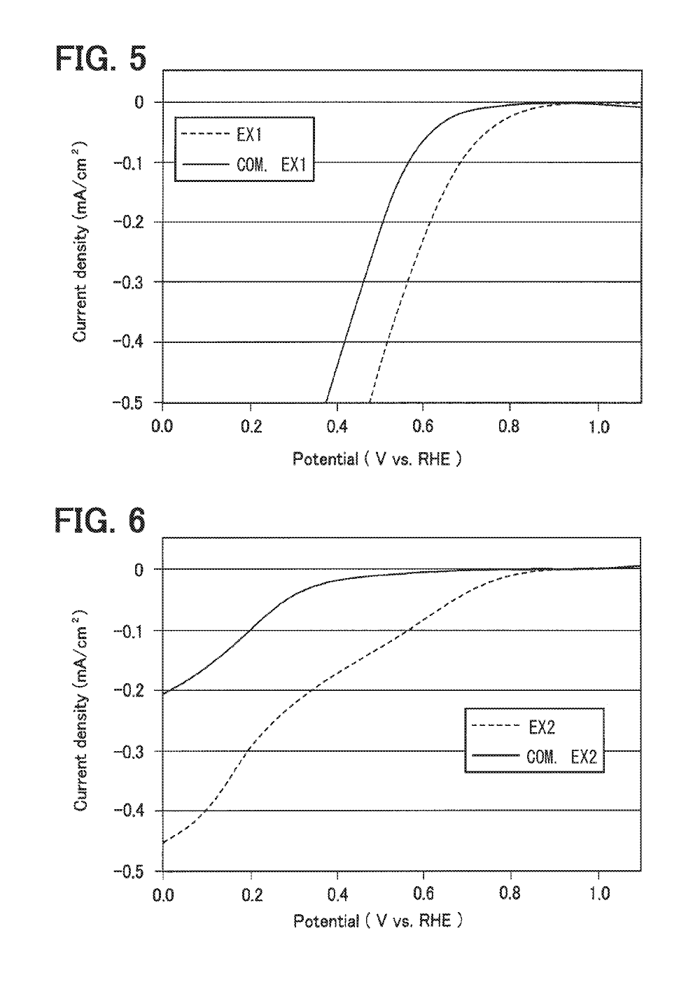

Next, results of evaluating oxygen reduction activities of Examples 1, 2 and Comparative Examples 1 to 3 will be described with reference to FIGS. 5 to 7. FIGS. 5 to 7 show variations of current value generated by sweeping potential from 1.12 V (vs. SHE) to 0 V (vs. SHE) in 10 mV/sec with an electrochemical measurement device.

As shown in FIG. 5, in Example 1 (100 mM of H₄PO₄⁺), current starts to flow faster than Comparative Example 1 (100 mM of H₃PO₄). This result indicates that redox reaction (that is, generation reaction of H₂O in the cathode electrode 130) Is promoted in Example 1 than in Comparative Example 1, and proton supply property to the Pt catalyst is higher in Example 1 than in Comparative Example 1.

As shown in FIG. 6, in Example 2 (10 mM of H₄PO₄⁺), current starts to flow faster than Comparative Example 2 (10 mM of H₃PO₄). This result indicates that redox reaction is promoted in Example 2 than in Comparative Example 2, and proton supply property to the Pt catalyst is higher in Example 2 than in Comparative Example 2.

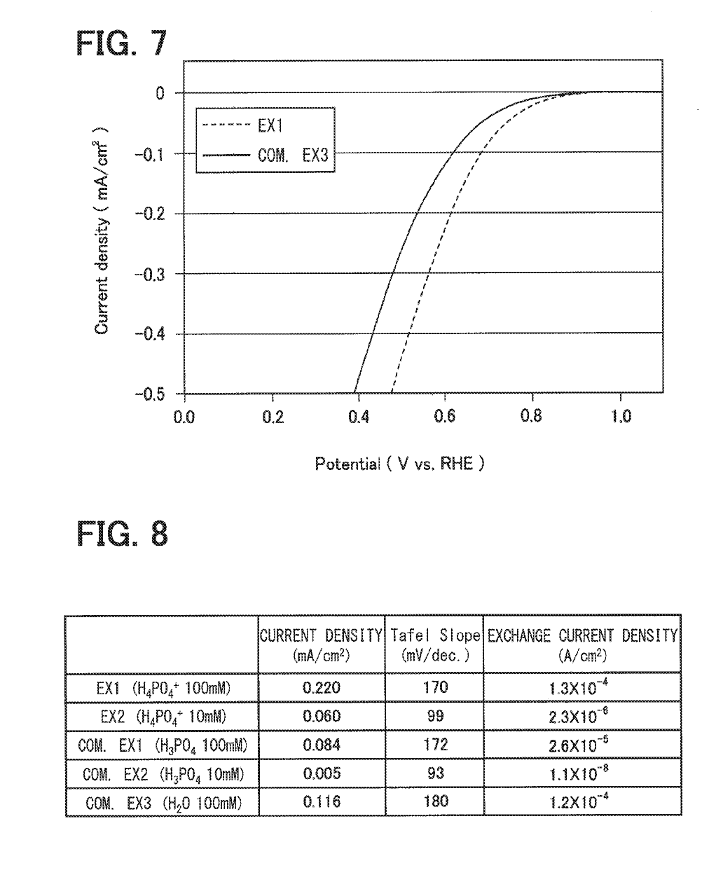

As shown in FIG. 7, in Example 1 (100 mM of H₄PO₄⁺), current starts to flow faster than Comparative Example 3 (100 mM of H₂O). This result indicates that redox reaction is promoted in Example 1 than in Comparative Example 3, and proton supply property to the Pt catalyst is higher in Example 1 than in Comparative Example 3.

Next, results of evaluating oxygen reduction activities of Examples 1, 2 and Comparative Examples 1 to 3 will be described with reference to FIG. 8. Tafel slope and exchange current density shown in FIG. 8 were calculated from current densities at 0.6 V in each example and each comparative example shown in FIGS. 5 to 7.

The exchange current density is a current when chemical reaction occurring at the cathode electrode 130 is in an equilibrium state. As the exchange current density increases, the current easily flows and the redox performance increases.

As shown in FIG. 8, the exchange current density of Example 1 (100 mM of H₄PO₄⁺) is higher than that of Comparative Example 1 (100 mM of H₃PO₄). In addition, in Example 1, the exchange current density equivalent to that of Comparative Example 3 using H₂O as a proton carrier was obtained. The exchange current density of Example 2 (10 mM of H₄PO₄⁺) is higher than that of Comparative Example 2 (10 mM of H₃PO₄). That is, when H₄PO₄⁺ is used as the proton carrier, the redox performance is improved as compared with the case where H₃PO₄ is used as the proton carrier.

Next, generation rate of H₄PO₄ when the cathode electrode 130 is formed by changing the molar ratio of H₃PO₄ to strong acid will be described using Examples 3 to 6 and Comparative Example 4. In Examples 3 to 6 and Comparative Example 4, Nafion (registered trademark of Du Pont) that is perfluorosulfonic acid polymer was used as a strong add.

In Examples 3 to 6 and Comparative Example 4, molar ratio of H₃PO₄ to Nation (that is, molar ratio of phosphoric add to strong acid) is different. The molar ratio of H₃PO₄ to Nafion is 0.5 in Example 3, 1.0 in Example 4, 2.0 in Example 5, 3.2 in Example 6, and 3.5 in Comparative Example 4.

In Example 3, 0.2 g of Pt (46.5 wt %)/C powder, 1.22 ml of 5% Nafion solution, 8.56 ml of ethanol, 0.96 ml of water and 8.07 ml of 85% H₃PO₄ were weighed, and dispersed and mixed with an ultrasonic homogenizer to prepare an electrode ink. In Examples 4 to 6 and Comparative Example 4, the amount of H₃PO₄ was varied with respect to Example 3, so that the molar ratio of H₃PO₄ to Nafion was adjusted as described above.

The electrode inks of Examples 3 to 6 and Comparative Example 4 prepared in the above compositions were applied to carbon cloth or the like by a spray method so that supported amount of Pt was adjusted to 0.3 mg/cm². The applied electrode was collected and ³¹P analysis was carried out by ³¹P-NMR (phosphorus 31 nuclear magnetic resonance spectroscopy). A sample for NMR measurement was prepared by adding KBr to the electrode powder such that KBr was adjusted to 5 wt %, and the sample was sealed in a sample tube. In the NMR measurement, 0 ppm of 85% H₃PO₄ was used as a reference.

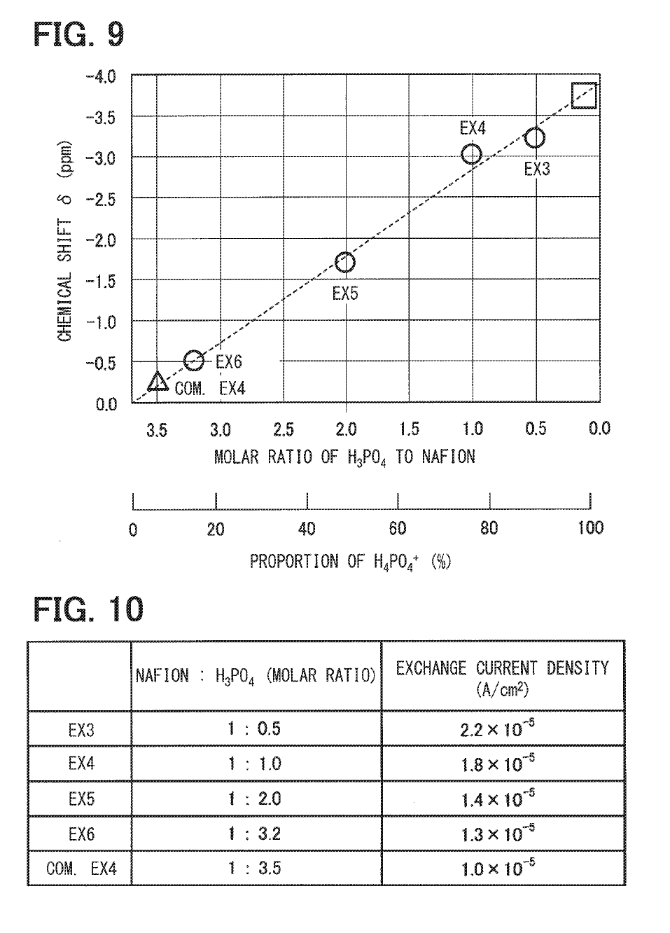

In FIG. 9, horizontal axis indicates molar ratio of H₃PO₄ to Nafion and vertical axis indicates chemical shift δ measured by ³¹P-NMR. In FIG. 9, circles indicate Examples 3 to 6, a triangle indicates Comparative Example 4, and a square indicates a point where proportion of H₄PO₄⁺ is 100%.

As shown in FIG. 9, values of chemical shifts δ in ³¹P-NMR was 3.2 ppm in Example 3, 3.0 ppm in Example 4, 1.7 ppm in Example 5, 0.5 ppm in Example 6, and 0.3 ppm in Comparative Example 4. That is, the value of the chemical shift δ in ³¹P-NMR is inversely proportional to the molar ratio of H₃PO₄ to Nafion.

Here, the molar ratio of H₃PO₄ to Nafion and the proportion of H₄PO₄⁺ will be explained. According to Yoshitaka Hisazumi, et. Al., “Determination of the association constants of H₄PO₄⁺ HSO₄^{- 31}P NMR cation-exchange methods”, J. inorg. Nucl. Chem., Vol. 39, pp 1615-1619 (1977)”, chemical shift amount of ³¹P-NMR is 3.8 ppm when the proportion of H₄PO₄⁺ is 100%. Further, the chemical shift amount of ³¹P-NMR is 0 ppm when the proportion of H₄PO₄⁺ is 0%. That is, as the value of the chemical shift δ increases, the proportion of H₄PO₄⁺ increases.

As shown in FIG. 9, as the molar ratio of H₃PO₄ to Nafion decreases, the proportion of H₄PO₄⁺ increases in a linear function. In Comparative Example 4 in which the molar ratio of H₃PO₄ to Nafion is 3.5, the value of the chemical shift δ is 0.3 ppm and the proportion of H₄PO₄⁺ is estimated to be about 7%.

In contrast, in Examples 3 to 6 in which the molar ratio of H₃PO₄ to Nation is 3.2 or less, the value of chemical shift δ of ³¹P is 0.5 ppm or more and the proportion of H₄PO₄⁺ is estimated to be 15% or more. Especially, in Examples 3 and 4 in which the molar ratio of H₃PO₄ to Nafion is 1.0 or less, the value of chemical shift δ of ³¹P is 3.0 ppm or more and the proportion of H₄PO₄ is estimated to be 75% or more. Therefore, the value of ³¹P chemical shift δ is preferably 0.5 ppm or more, and the molar ratio of H₃PO₄ to Nafion is preferably 3.2 or less. Further, the value of ³¹P chemical shift δ is more preferably 3.0 ppm or more, and the molar ratio of H₃PO₄ to Nafion is more preferably 1.0 or less.

Next, each electrode of Examples 3 to 6 and Comparative Example 4 were attached to the electrolyte membrane to prepare an electrolyte membrane electrode assembly (MEA), and the exchange current density of the MEA was derived.

A 15 mm square hydrophilized Teflon (registered trademark) membrane filter (made by Merck Millipore) was placed on a Teflon (registered trademark) board and the corners of each side were fixed with a tape. Then, an electrolyte membrane raw material solution prepared by dispersing 50 mg of the coordination polymer powder in 3 ml of water was applied to the membrane filter to prepare an electrolyte membrane. Application of the electrolyte membrane raw material solution was carried out by spray coating until the amount of the coordination polymer powder reached 1 mg/2.25 cm². Electrodes prepared in Examples 3 to 6 and Comparative Example 4 were attached to both sides of the obtained electrolyte membrane to prepare an MEA.

Next, the MEA was heated to 120° C. while supplying 3.8% hydrogen to one electrode of the MEA and dry air to the other electrode at a flow rate of 60 mL/min. Then, after the temperature stabilized, battery performance was evaluated by sweeping from the open circuit voltage to 0.6 V at a rate of 0.2 mV/sec. The obtained cyclic voltammogram was fitted with the exchange current density and the inclination of Tafel as variables using Butler-Volma equation to derive the exchange current density which is an index of the oxygen reduction activity.

As shown in FIG. 10, as the molar ratio of H₃PO₄ to Nafion decreases, the exchange current density increases. In other words, as the molar ratio of H₃PO₄ to Nafion decreases, the proportion of H₄PO₄⁺ increases, and as a result, the redox performance is considered to increase.

Hereinafter, additional comparative examples of the above embodiment will be described.

Suppose that water (H₂O) is used as a carrier for a fuel battery. In this case, the fuel battery can be used only in a temperature range where water can exist in the electrolyte, that is, less than 100° C. When the operating temperature of the fuel battery is low, activity of Pt catalyst is lowered. As a result, the amount of Pt may be increased in order to maintain power generation performance. Also, a large radiator for cooling the fuel battery and a unit for controlling humidity of the electrolyte membrane may be required. Accordingly, the cost of the solid polymer type fuel battery may be increased.

Suppose that a mixture of a binder, a Pt catalyst, and H₃PO₄ is used as an electrode for a fuel battery and H₃PO₄ is used as a proton carrier. In this electrode, for example, polytetrafluoroethylene (PTFE), polyvinylidene fluoride (PVDF), polybenzimidazole, polyetherketone, polyetherimide, polysulfone or perfluorosulfonic acid may be used as a binder, and H₃PO₄ is doped to accomplished electrode.

When H₃PO₄ is used as the proton carrier, proton supply property to the Pt catalyst is low. At the cathode electrode, H₃PO₄ may be adsorbed on Pt to lower the catalytic activity. Further, since H₃PO₄ may be eluted from the binder with the lapse of use time, ion conductivity may be lowered and the catalytic activity may be lowered. Accordingly, when H₃PO₄ is used as the proton carrier, oxygen reduction performance of the electrode may be lowered.

According to the present embodiment described above, H₄PO₄⁺ is used as the proton carrier of the cathode ionomer 131b in the cathode electrode 130 of the fuel battery cell 100. H₄PO₄⁺ has higher proton supply property to Pt catalyst than H₃PO₄. Further, since H₄PO₄⁺ is less likely adsorbed on the Pt catalyst at the cathode potential in the operation range of the fuel battery cell 100, degradation in catalyst activity is suppressed. Therefore, the redox performance of the cathode electrode 130 according to the present embodiment can be improved compared to the case where H₃PO₄ is used as the proton carrier.

When the strong add polymer having the sulfone group is used as the cathode ionomer 131b, the sulfone group of the strong add polymer and H₄PO₄⁺ strongly bind by ionic bond. Therefore, H₄PO₄⁺ is not easily eluted from the cathode electrode 130 even when the fuel battery cell 100 is used for a long time. This also improves the redox performance of the cathode electrode 130 of the present embodiment.

### Other Embodiments

The present disclosure is not limited to the embodiment described hereinabove, but may be modified in various ways as hereinbelow without departing from the gist of the present disclosure. Means disclosed in each embodiment described hereinabove may be appropriately combined within a range that can be implemented.

(1) In the above embodiment, the example in which the redox reaction electrode of the present disclosure is applied to the electrode for the fuel battery has been described. However, the present disclosure is not limited to the example, and the redox reaction electrode of the present disclosure may be applied to any electrode that conducts proton to undergo redox reaction.

(2) In the above embodiment, the catalyst carrying carbon 131a is coated with the ionomer 131b. However, it is not always necessary to coat the catalyst carrying carbon 131a with the ionomer 131b. For example, a liquid ionomer may be used.

(3) In the above embodiment, the example using the coordination polymer as the electrolyte membrane 110 has been described. However, the type of the electrolyte membrane 110 is not limited to the example, and different types of electrolyte membrane 110 may be used.

(4) In the above embodiment, the anode electrode 120 has different configuration from the cathode electrode 130. However, the present disclosure is not limited to the example, and the anode electrode 120 may have the same configuration as the cathode electrode 130. That is, the redox reaction electrode of the present disclosure may be applied to the anode electrode 120 and H₄PO₄⁺ may be used as the proton carrier of the anode ionomer 121b.

Optional aspects of the present disclosure will be set forth in the following clauses.

According to a first aspect of the present disclosure, a redox reaction electrode includes a catalyst carrier, a Pt catalyst supported on the catalyst carrier, and an ionomer having proton conductivity. The ionomer contains H₄PO₄⁺.

H₄PO₄⁺ contained in the ionomer has a proton supply property to the Pt catalyst higher than H₃PO₄. Also, H₄PO₄⁺ is less likely to be adsorbed on the Pt catalyst, thereby suppressing degradation of catalytic activity. Therefore, the redox performance of the redox reaction electrode according to the first aspect of the present disclosure can be improved compared to the case where H₃PO₄ is used as the proton carrier.

According to a second aspect of the present disclosure, a fuel battery includes the redox reaction electrode according to the first aspect of the present disclosure and an electrolyte disposed to be in contact with the redox reaction electrode.

While only the selected exemplary embodiment and examples have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiment and examples according to the present disclosure is provided for illustration only, and not for the purpose of limiting the disclosure as defined by the appended claims and their equivalents.

What is claimed is:

1. A redox reaction electrode comprising:
a catalyst carrier;
a Pt catalyst supported on the catalyst carrier; and
an ionomer having proton conductivity, wherein
the ionomer contains H₄PO₄⁺.

2. The redox reaction electrode according to claim 1, wherein
peak shift δ of ³¹P-NMR is 0.5 ppm or more.

3. The redox reaction electrode according to claim 1, wherein
the ionomer further contains a strong add having acidity higher than H₃PO₄.

4. The redox reaction electrode according to claim 3, wherein
molar ratio of phosphoric add to the strong add in the ionomer is 1 or less.

5. The redox reaction electrode according to claim 3, wherein
the strong acid includes a strong acid polymer having a sulfone group.

6. The redox reaction electrode according to claim 3, wherein
the strong add includes at least one add selected from the group consisting of sulfuric acid, hydrochloric add, nitric acid, perchloric acid, trifluoromethanesulfonic add, and 1,1,1-trifluoro-N-[(trifluoromethyl)sulfonyl]methanesulfonamide.

7. The redox reaction electrode according to claim 1, wherein
the redox reaction electrode is used in a fuel battery for generating electric energy by causing a fuel gas and an oxidant gas to undergo electrochemical reaction.

8. The redox reaction electrode according to claim 7, wherein
the redox reaction electrode is supplied with the oxidant gas.

9. A fuel battery comprising:
the redox reaction electrode according to claim 1; and
an electrolyte disposed to be in contact with the redox reaction electrode.
